(19) United States
(12) Patent Application Publication
(10) Pub. No.: US 2015/0173422 A1
(43) Pub. Date: Jun. 25, 2015

(54) ELECTRONIC CIGARETTE

(71) Applicant: KIMREE HI-TECH INC., Tortola (VG)

(72) Inventor: Qiuming Liu, Huizhou City (CN)

(21) Appl. No.: 14/412,444

(22) PCT Filed: May 20, 2013
(86) PCT No.: PCT/CN2013/075940

§ 371 Date: Dec. 31, 2014

(30) Foreign Application Priority Data
Mar. 26, 2013 (CN) PCT/CN2013/073223

(51) Int. Cl. A24F 47/00; H05B 1/02

(52) U.S. Cl. CPC A24F 47/008; H05B 1/0244

(57) ABSTRACT

Disclosed is an electronic cigarette, comprising a suction stem (10) and a power supply rod (20), wherein the suction stem (10) comprises a suction cylinder (11), and an end of the suction stem (10) is provided with a suction nozzle cover (13). The electronic cigarette further comprises a gas valve (16). By the means of the gas valve (16), the electronic cigarette will not be smoked once it is brought into the mouth of a person, effectively preventing children and infants from sucking the electronic cigarette as a toy.

### FIELD OF THE INVENTION

The present invention relates to electronic cigarettes, and particularly relates to an electronic cigarette capable of preventing infant smoking by accident.

### BACKGROUND OF THE INVENTION

Electronic cigarette is a simulation cigarette, using a heating wire to heat and vaporize fragrance-containing materials to produce aerosol for users smoking However, conventional electronic cigarette is available for smoking right after taking in mouth, then easy to cause infant smoking by accident.

### SUMMARY OF THE INVENTION

Accordingly, an objective of the present invention provides an electronic cigarette capable of preventing infant smoking by accident.

To achieve the aforementioned objective, the present invention provides an electronic cigarette, including a suction stem and a power supply rod. The suction stem includes a suction cylinder, and a suction nozzle cover is provided at one end of the suction stem. The electronic cigarette further comprises a gas valve. Therefore, by using the gas valve, the electronic cigarette is no longer available for smoking right after taking in mouth, which effectively prevents infant smoking by accident like a toy.

Furthermore, as an embodiment, the gas valve includes a bottom seat and a plurality of columns disposed at a first side of the bottom seat, the columns defines gaps therebetween to coordinately form a ventilation groove for aerosol flowing. The gaps make the gas valve easy to install. When one end of the column is pressed, there is space relative to near the deformation and then facilitate the gas valve to be inserted into a through-hole of the suction nozzle cover. Preferably, the bottom seat and the columns are integrally formed to a structure; the structure is simple and practical, convenient for using.

Furthermore, a bottom of the ventilation groove is formed by a part area of the first side. Specifically, a plan view of the cross section of the ventilation groove relative to the first side of the bottom seat locates within the first side. An area from the plan view area within the first side forms a sealing part operable to seal, which guarantees a tightness of the gas valve when closed.

Furthermore, preferably the number of columns is two, the cross-section of the column is arcuate, planar surfaces of the two columns are opposite to each other and the two columns are symmetrical disposed.

Furthermore, as an alternative embodiment, the gas valve includes a bottom seat and a column disposed at the first side of the bottom seat; the column axially defines a cavity therein; a distal end of the column radially defines an air vent therein; the air vent communicates with an aerosol passage in the suction stem and the cavity; the first side of the bottom seat defines a groove therein; the groove is formed by the cavity extending from the first side toward the second side of the bottom seat; the groove communicates the cavity with outside. The groove structure makes the ventilation groove still capable to ventilate with outside after pressing the gas valve, then guarantees the ventilation smoothness.

Furthermore, a wall of the through-hole of the suction nozzle cover extends inward to form a sidewall; the sidewall blocks the air vent when pulling out the gas valve, and exposes the air vent when pressing the gas valve. Therefore, the air vent and the sidewall matchingly form a switch structure, guaranteeing the smooth flow between the aerosol passage and the outside after pressing the gas valve.

Furthermore, a distal end of the column extends outward to form a stopping part capable of preventing the gas valve escaping from the through-hole of the suction nozzle cover. The stopping part is barb-shaped, then effectively to prevent the gas valve escaping from the through-hole of the suction nozzle cover by excessive force. A distal end of the stopping part is gradually larger toward the direction of the bottom seat, then facilitate to be inserted into the through-hole of the suction nozzle cover.

Furthermore, the bottom seat is truncated cone-shaped, and a diameter of the first side opposite to the suction nozzle cover is smaller than a diameter of the second side. Therefore, the cone is small and compact, and a slanted side surface structure of the cone gradually sloping from inside to outside makes it easy for adult users to pull out the gas valve by fingers, and the operation is easy. However, infants' fingers are often clumsy and it is not easy to pull out the gas valve. The second side of the bottom seat is planar structure, facilitating users to press the gas valve.

Furthermore, the suction stem further comprises a first connector disposed at the other end of the suction cylinder and used to connect with the power supply rod.

Furthermore, the power supply rod includes a battery tube and a battery disposed in the battery tube; one end of the battery tube is provided with a second connector coupled to the first connector, the other end of the battery tube is equipped with a switch module and a light cap assembly.

Furthermore, both the first connector and the second connector comprises an outer electrode ring, an insulation ring and an inner electrode in turn nested.

Preferably, the suction stem further comprises an atomizer disposed in the suction cylinder for generating smoking The atomizer comprises an atomization chamber, a liquid-storage piece is fitted on a catheter to form the atomization chamber therein, and two ends of them being sealed. A heater is disposed in the atomization chamber. Two ends of the atomization chamber are sealed by a liquid-blocking seat and the outer electrode ring respectively.

Furthermore, the atomizer includes an atomization chamber composed of a liquid-storage piece and a catheter which are in turn nested, and of which two ends are sealed, and a heater disposed in the atomization chamber; two ends of the atomization chamber are sealed by a liquid-blocking seat and the outer electrode ring respectively.

Furthermore, the heater includes a liquid-guiding piece of which two ends extend out of an outer sidewall of the catheter and mutually abuts with the liquid-storage piece, and a heating wire winding on an outer surface of the liquid-storage piece; two ends of the heating wire are electrically connected to the inner electrode and the outer electrode ring respectively.

Preferably, the gas valve is rotatably fitted to the suction nozzle cover. The suction nozzle cover comprises a bottom wall and an annular side wall longitudinally extending from a periphery of the bottom wall, and the bottom wall defines a suction hole. The gas valve is by a bottom cover and an annular side wall longitudinally extending from a periphery of the bottom cover, and the bottom cover defines a via hole selectably connected with the suction hole.

Preferably, the bottom wall of the suction nozzle cover racially extends outwards to form an annular mounting flange; the gas valve defines an annular groove in its side wall inner; and the annular mounting flange is fitted in the annular groove.

Preferably, the side wall of the suction nozzle cover forms a mounting step; and the distal end of the side wall of the gas valve rests on the mounting step.

the gas valve comprises a sealing stopper inserted in the suction nozzle cover and a valve cover flexibly connected with the sealing stopper; the sealing stopper defines a smoke outlet communicated with an inner of the suction nozzle cover; and the valve cover comprises a flexible connection flexibly connected with the sealing stopper, a lip connected with the connection, and a sealing column formed on the lip for tightly inserted in the smoke outlet.

In accordance with another embodiment of the present invention, the power supply rod comprises a first power cylinder with the battery therein and a second power cylinder slidably sleeved with the first power cylinder, and the gas valve is set between the two power cylinders. The gas valve comprises a valve plug disposed in an inner wall of the first power cylinder and a sealing sheath disposed in an inner wall of the second power cylinder. The valve plug comprises an inserting portion fixed in the inner wall of the first power cylinder and a sliding column extending from one end of the inserting portion and axially extending towards the second power cylinder; an inner of the sliding column defines a cavity communicated with an inner of the inserting portion; and a side wall of the sliding column defines a vent hole communicated with the cavity.

The sealing sheath is sleeved on the sliding column, when the second power cylinder is departed from the first power cylinder, the sealing sheath completely seals off the vent hole

Preferably, an end of the sliding column is sleeved with a stopping ring to prevent the sealing sheath sliding off the sliding column.

The advantage of the present invention are: the gas valve is removably embedded in the through-hole of the suction nozzle cover and the gas valve serves as a switch for the inhalation port of aerosol passage, thereby the electronic cigarette is no longer available for smoking right after taking in mouth, which effectively prevents infant inhaling the electronic cigarette by mistake like a toy.

### BRIEF DESCRIPTION OF THE DRAWINGS

FIG. 1 is a schematic view of a whole structure of an electronic cigarette according to an embodiment of the present invention;

FIG. 2 is a side sectional view along line A-A of the electronic cigarette shown in FIG. 1;

FIG. 3 is an exploded view of the electronic cigarette according to the embodiment of the present invention;

FIG. 4 is a schematic view of a first state of the electronic cigarette according to the embodiment of the present invention;

FIG. 5 is a schematic view of a second state of the electronic cigarette according to the embodiment of the present invention;

FIG. 6 is a schematic view of the gas valve in an opening state of the electronic cigarette according to a first embodiment of the present invention;

FIG. 7 is a schematic view of the gas valve in a closing state of the electronic cigarette according to the first embodiment of the present invention;

FIG. 8 is a schematic view of the gas valve in a closing state of the electronic cigarette according to a second embodiment of the present invention;

FIG. 9 is a schematic view of the gas valve in an opening state of the electronic cigarette according to the second embodiment of the present invention;

FIG. 10a is a schematic view of the gas valve in an opening state of the electronic cigarette according to a third embodiment of the present invention;

FIG. 10b is an enlarged view of Section A of the electronic cigarette in FIG. 10a;

FIG. 10c is a schematic view of the gas valve in a closing state of the electronic cigarette according to the third embodiment of the present invention;

FIG. 11a is a schematic view of the gas valve in a closing state of the electronic cigarette according to a fourth embodiment of the present invention;

FIG. 11b is a schematic view of the gas valve in an opening state of the electronic cigarette according to the fourth embodiment of the present invention;

FIG. 12a is a schematic view of the gas valve in an opening state of the electronic cigarette according to a fifth embodiment of the present invention; and

FIG. 12b is a schematic view of the gas valve in a closing state of the electronic cigarette according to the fifth embodiment of the present invention.

### DETAILED DESCRIPTION OF THE INVENTION

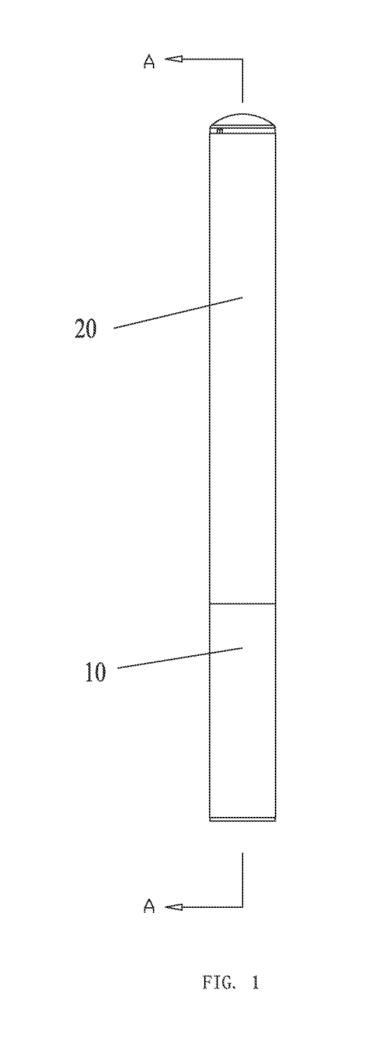

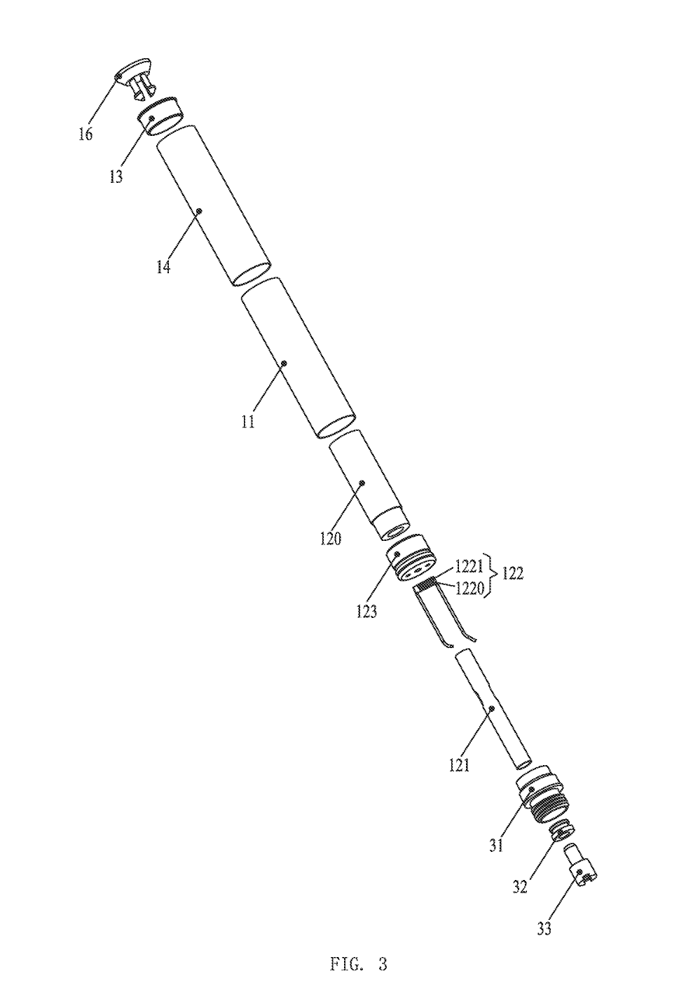

Referring to FIG. 1 to FIG. 3, the present invention provides an electronic cigarette capable of preventing infant smoking by accident, no smoking will happen when infants taking the electronic cigarette in mouth for fun. The electronic cigarette includes a suction stem 10 and a power supply rod 20 which are interconnected.

The suction stem 10 includes a suction cylinder 11, an atomizer 12 disposed in the suction cylinder 11 and used to produce aerosol, a suction nozzle cover 13 embedded in one end of the suction cylinder 11, and a first connector disposed at the other end of the suction cylinder 11 to connect with the power supply rod 20. In the embodiment, an outer surface of the suction cylinder 11 is sheathed with a sticker 14 for decoration and protective effect.

The suction cylinder 11 is barrel-shaped. A gas valve 16 is movably embedded in a through-hole of the suction nozzle cover 13 and serves as a switch for a suction hole of an aerosol passage. The gas valve 16 includes a bottom seat 160 and several columns 162 disposed at an first side of the bottom seat 160. The columns 162 defines gaps therebetween to coordinately form a ventilation groove 1621 for aerosol flowing.

The bottom seat 160 is truncated cone-shaped, and a diameter of the first side opposite to the suction nozzle cover 13 is smaller than that of an second side. Therefore, the cone is small and compact, and a slanted surface structure of the truncated cone gradually sloping from inside to outside makes it easy for adult users to pull out the gas valve 16 by fingers, and the operation is easy. However, infants' fingers are often clumsy and it is not easy for infants to pull out the gas valve 16. The second side of the bottom seat 160 is a planar structure, which facilitates the user to press the gas valve 16.

A distal end of the column 162 extends outwardly to form a stopping part capable of preventing the gas valve 16 escaping from the through-hole of the suction nozzle cover 13. There are two columns 162, and the cross-section of the columns is arcuate. Planar surfaces of the two columns 162 are opposite to each other and the two columns are symmetrical disposed.

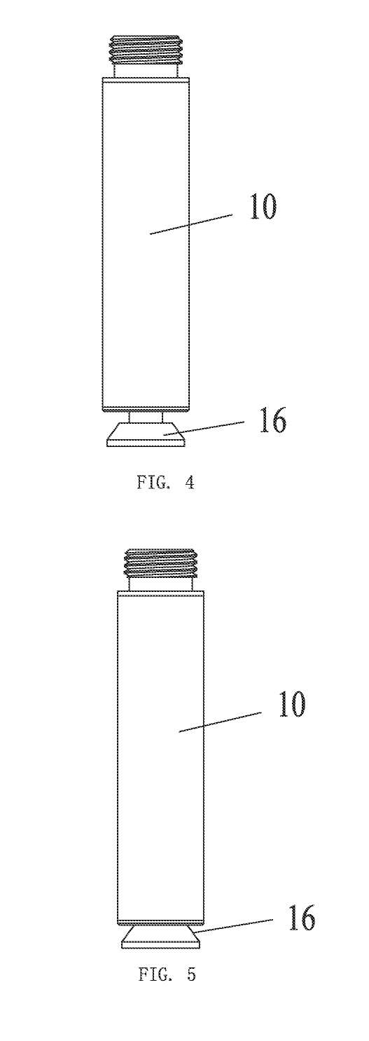

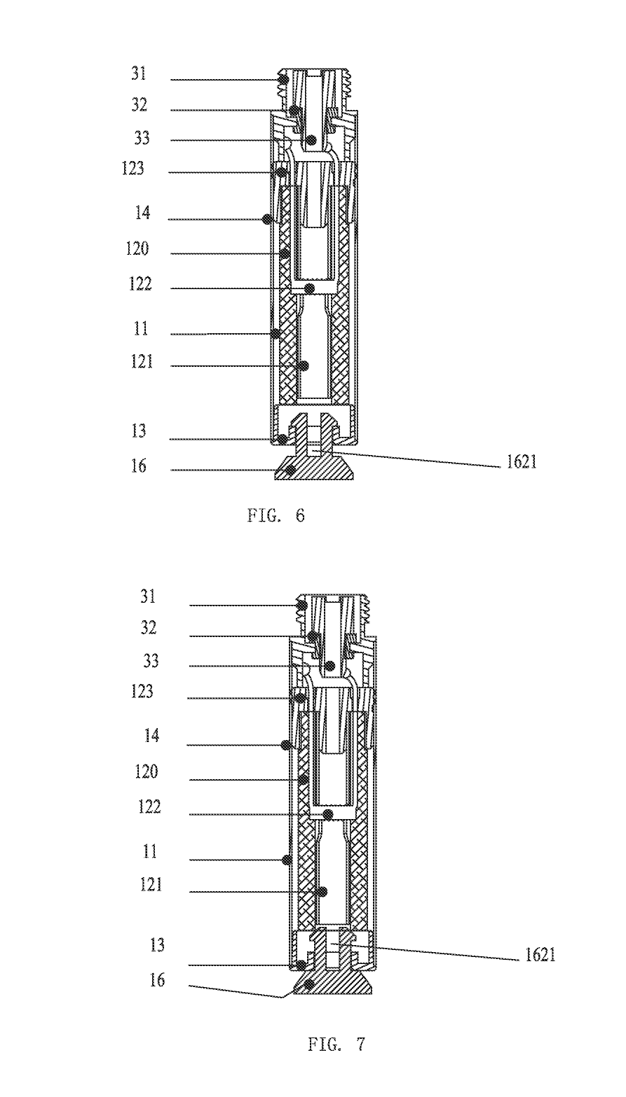

Referring to FIG. 4 to FIG. 7, in accordance with the first embodiment, pulling out the gas valve 16, the electronic cigarette is in a ventilation state (as a first state shown in FIG. 4 and FIG. 6), it is available for user to smoke the electronic cigarette. Pressing the gas valve 16, the electronic cigarette is in a blocked state (as a second state shown in FIG. 5 and FIG. 7), it is unavailable to smoke the electronic cigarette. Specifically, a bottom of the ventilation groove 1621 is formed by a part of the first side. The projection area of the cross section of the ventilation groove 1621 towards the first side of the seat 160 locates within the first side. An area expanding outwards from the projection area in the first side forms a sealing part operable to seal, which guarantees a tightness of the gas valve 16 when closed.

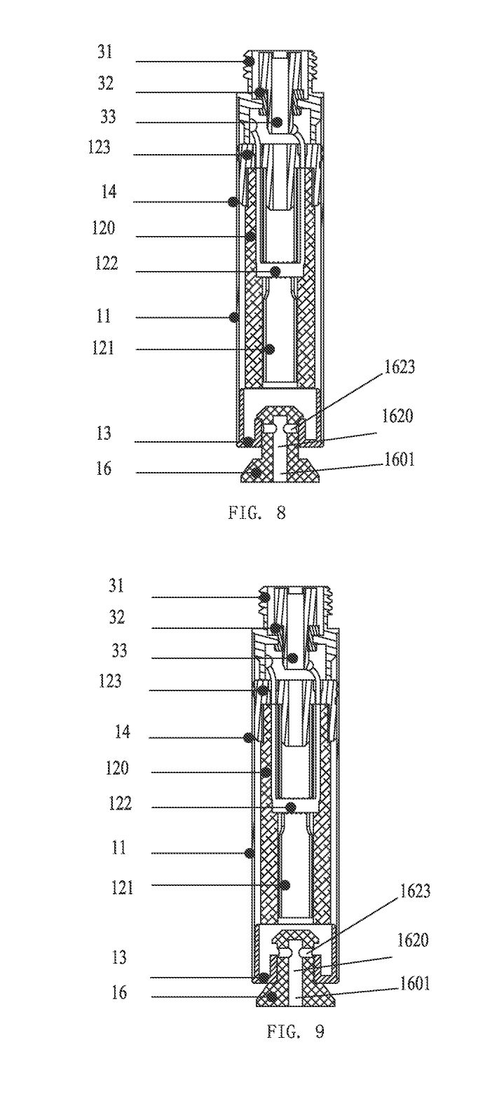

Referring to FIG. 4, FIG. 5, FIG. 8 and FIG. 9, as a second embodiment, pulling out the gas valve 16, the electronic cigarette is in a blocked state (as the first state shown in FIG. 4 and FIG. 8), it is unavailable to smoke the electronic cigarette; pressing the gas valve 16, the electronic cigarette is in a ventilation state (as a second state shown in FIG. 5 and FIG. 9), it is available for smoking the electronic cigarette. Specifically, the gas valve 16 includes the bottom seat 160 and the column 162 disposed at the first side of the bottom seat 160. The column 162 axially defines a cavity 1620 therein. A distal end of the column 162 radially defines an air vent 1623 therein. The air vent 1623 communicates with the aerosol passage in the suction stem 10 and the cavity 1620. The first side of the bottom seat 160 defines a groove 1601 therein. The groove 1601 is formed by the cavity 1620 extending from the first side to the second side through the seat 160. The groove 1601 makes the cavity 1620 communicating to outside. Structure of the groove 1601 makes the ventilation groove 1621 still capable to ventilate with outside after pressing the gas valve 16, then guarantees the ventilation smoothly. And, a wall of a suction hole of the suction nozzle cover 13 extends inward to form a sidewall. The sidewall blocks the air vent 1623 when pulling out the gas valve 16, and exposes the air vent 1623 when pressing the gas valve 16. Therefore, the cooperation of the ventilation hole 1623 and the sidewall forms a switch structure, which guarantees the smoothly flow between the aerosol passage and the outside after pressing the gas valve 16.

The atomizer 12 includes an atomization chamber formed by a liquid-storage piece 120 and a catheter 121 being sleeved each other and with their two ends being sealed, and a heater 122 disposed in the atomization chamber. Two ends of the atomization chamber are sealed by a liquid-blocking seat 123 and an outer electrode ring 31 respectively. The heater 122 includes a liquid-guiding piece 1220, of which two ends extend out of an outer sidewall of the catheter 121 and mutually abuts with the liquid-storage piece 120, and a heating wire 1221 winding on an outer surface of the liquid-storage piece 1220. Two ends of the heating wire 1221 are electrically connected to an inner electrode 33 and the outer electrode ring 31 respectively. In the embodiment, the liquid-storage piece 120 is liquid-storage cotton, the catheter 121 is a kind of fiberglass tube, and the liquid-guiding piece 1220 is a liquid-guiding wick.

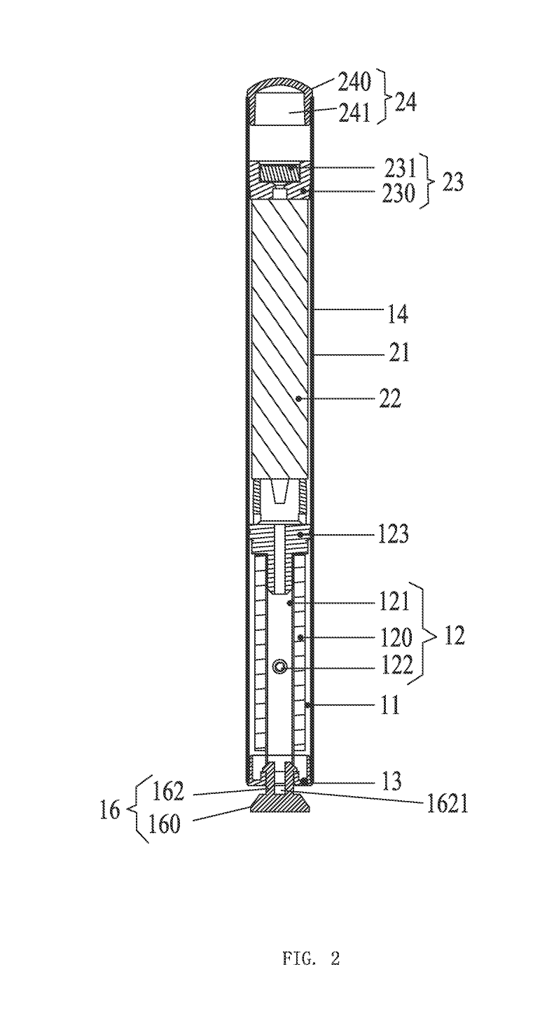

Referring to FIG. 2, the power supply rod 20 includes a battery tube 21 and a battery 22 disposed in the battery tube 21. One end of the battery tube 21 is provided with a second connector coupled to the first connector, and the other end of the battery tube 21 is equipped with a switch module 23 and a light cap assembly 24. The switch module 23 includes a supporting seat 230 and an airflow sensor 231 fixed on the supporting seat 230. The light cap assembly 24 includes a light cap 240 and a LED light 241 disposed in the inside, and being red, and used to simulate burning cigarette to indicate state.

Both the first connector and the second connector comprise the outer electrode ring 31, an insulation ring 32 and the inner electrode 33 in turn nested. The insulation ring 32 is used for the insulation between the outer electrode ring 31 and the inner electrode 33.

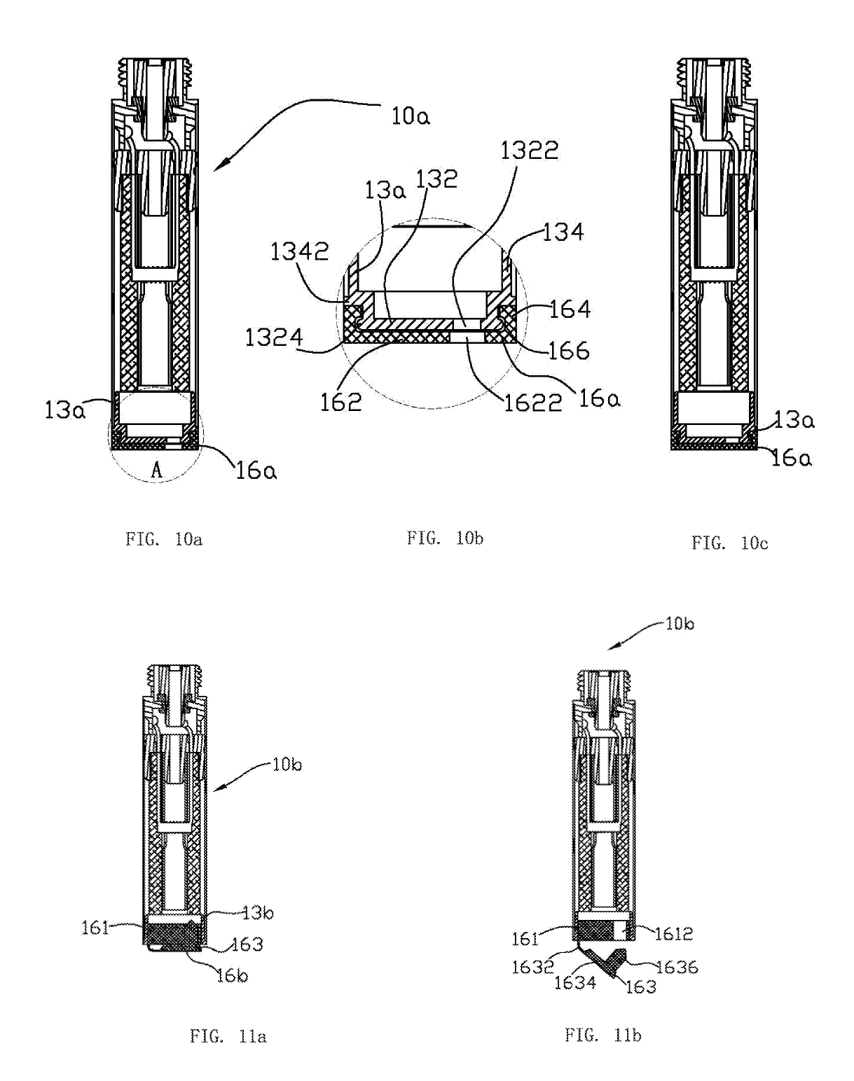

In accordance with the third embodiment as shown in FIGS. 10a-10c, the electronic cigarette is similar to the first and second embodiments, herein only differences will be described. Referring to FIGS. 10a-10c, one end of the suction stem 10a (namely its bottom) is provided with a suction nozzle cover 13a, and the gas valve 16a is rotatably sleeved with the suction nozzle cover 13a. The suction nozzle cover 13a comprises a bottom wall 132 and an annular side wall 134 longitudinally extending from a periphery of the bottom wall 132. The bottom wall 132 defines a suction hole 1322. The gas valve 16a comprises a bottom cover 162 and a side wall 164 longitudinally extending from a periphery of the bottom cover 162, and the bottom cover 162 defines a via hole 1622 selectably connected with the suction hole 1322.

When the gas valve 16a is rotated relative to the suction nozzle cover 13a for a certain angle, the via hole 1622 right communicates with the suction hole 1322, then when the user smokes via the electronic cigarette, smoke mist can flow into the user's mouth from the suction hole 1322 through the via hole 1622. Otherwise, when the gas valve 16a is further rotated relative to the suction nozzle cover 13a, the via hole 1622 is synchronously rotated together with the gas valve 16a, then the via hole 1622 and the suction hole 1322 are offset one another, namely, the via hole 1622 is blocked by the bottom wall 132 of the suction nozzle cover 13a except the suction hole 1322, and smoke mist is blocked flowing out from the suction nozzle cover 13a. Usually, the infant has no idea of rotating the gas valve 16a due to its mind. Therefore, even the infant accidentally suctions the suction nozzle cover 13a of the electronic cigarette in its mouth, no smoke mist will be inhaled, which guarantees infant safe and healthy.

Preferably, the bottom wall 132 of the suction nozzle cover 13a racially extends outwards to form an annular mounting flange 1324; correspondingly, the gas valve 16a defines an annular groove 166 in its side wall 164 inner; and the annular mounting flange 1324 is fitted in the annular groove 166, thereby the gas valve 16a is axially positioned relative to the suction nozzle cover 13a.

Preferably, the side wall 134 of the suction nozzle cover 13a forms a mounting step 1342; and the distal end of the side wall 164 of the gas valve 16a rests on the mounting step 1342, which further prevents axial rotation between the suction nozzle cover 13a and the gas valve 16a.

In accordance with a fourth embodiment of the present invention as shown in FIGS. 11a-11b, the electronic cigarette is similar to the third embodiment, herein only difference will be described. Referring to FIGS. 11a-11b, one end of the suction stem 10b (namely its bottom) is inserted with a suction nozzle cover 13b, and the gas valve 16b is fitted to the suction nozzle cover 13b. The gas valve 16b comprises a sealing stopper 161 inserted in the suction nozzle cover 13b and a valve cover 163 flexibly connected with the sealing stopper 161; the sealing stopper 161 defines a smoke outlet 1612 communicated with an inner of the suction nozzle cover 13b; and the valve cover 163 comprises a flexible connection 1632 flexibly engaged with the sealing stopper 161, a lip 1634 connected with the flexible connection 1632, and a sealing column 1636 formed on the lip 1634 for tightly inserted in the smoke outlet 1612.

The sealing column 1636 is tightly inserted in the smoke outlet 1612, by which smoke mist is interrupted from the inner to the outside of the electronic cigarette. If the user desires smoke, he only needs to pull the sealing column 1636 out of the smoke outlet 1612. Usually, the infant has no idea of pulling the sealing column 1636 out of the smoke outlet 1612 due to its age; therefore, it can prevent the infant accidently inhaling smoke and guarantee its safety and health.

Please note that: in above amendments, the gas valve is fitted to the suction nozzle cover. However, in other embodiments of the present invention, the gas valve can also be fitted to the atomizer or the power supply rod, which also has the advantage like the above amendments to prevent infant smoking by accident so as to ensure its safety and health.

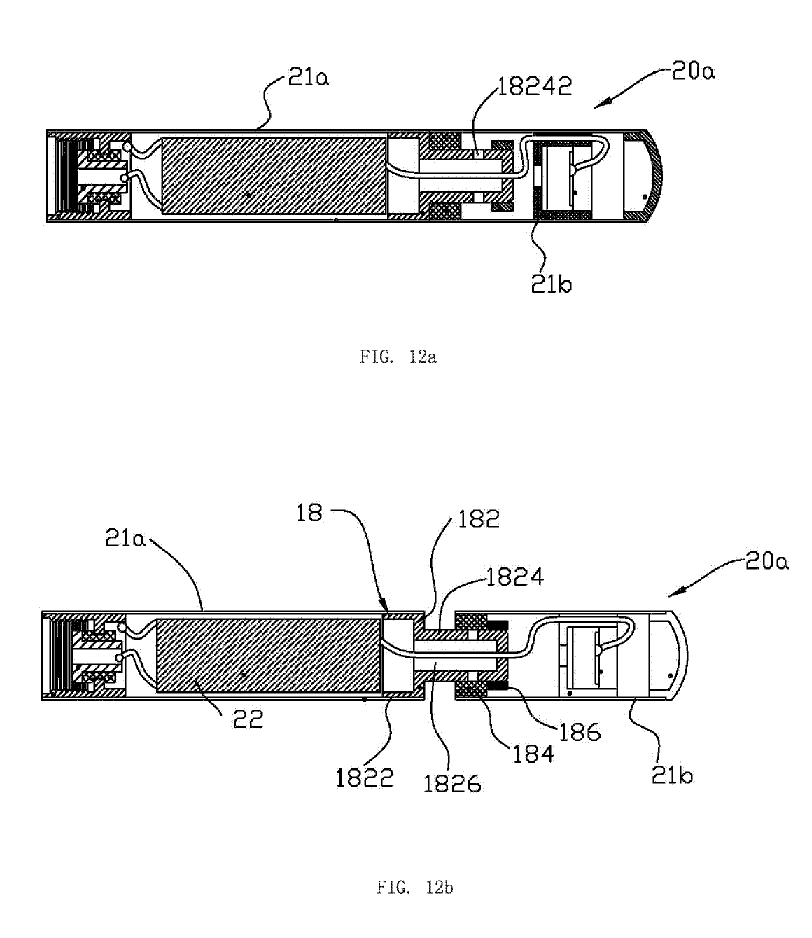

For example, as the fifth embodiment of the present invention as show in FIGS. 12a-12b, the power supply rod 20a comprises a first power cylinder 21a with the battery 22 therein and a second power cylinder 21b slidably sleeved with the first power cylinder 21a. The gas valve 18 is set between the two power cylinders.

The gas valve 18 comprises a valve plug 182 disposed in an inner wall of the first power cylinder 21a and a sealing sheath 184 disposed in an inner wall of the second power cylinder 21b. The valve plug 182 comprises an inserting portion 1822 fixed in the inner wall of the first power cylinder 21a and a sliding column 1824 extending from one end of the inserting portion 1822 and axially towards the second power cylinder 21b; an inner of the sliding column 1824 defines a cavity 1826 communicated with the inserting portion 1822 inner; and a side wall of the sliding column 1824 defines a vent hole 18242 communicated with the cavity 1826. The sealing sheath 184 is sleeved on the sliding column 1824, when the second power cylinder 21b is departed from the first power cylinder 21a, and the sealing sheath 184 completely seals off the vent hole 18242 in the sliding column 1824, thereby the cavity 1826 is closed off with outside. Because the cavity communicates with the aerosol passage in the electronic cigarette, substantially, the aerosol passage is closed off with outside, which can prevent the infant smoking by accident, further guarantee safety.

Preferably, an end of the sliding column 1824 is sleeved with a stopping ring 186 to prevent the sealing sheath 184 sliding off the sliding column 1824, and so as to prevent the second power cylinder 21b sliding off the first power cylinder 21a.

It is understood, the power supply rod 20 can be replaced with a structure adapted to a high-capacity battery to supply power. The high-capacity battery is available in the art, and is embedded in the suction stem 10. Then an appropriate gas valve 16 may be set in the suction stem 10, or at the smoke outlet of the atomizer, or in the suction nozzle cover 13 so as to prevent the infant smoking by accident.

In another embodiment, the electronic cigarette has no power supply rod, but the smoke mist is generated by vaporization of compressed gas. Then the appropriate gas valve 16 is set in the suction stem 10 or in the suction nozzle cover 13 so as to prevent the infant smoking by accident.

In a further embodiment, the electronic cigarette has a soft end of the suction stem instead of the suction nozzle cover 13. Then the appropriate gas valve 16 is set in the suction stem 10 or in the end of the suction stem 10 so as to prevent the infant smoking by accident.

Embodiments of the present invention is shown and described in the above-mentioned. Various improvement and modifications can be made to the embodiments by those skilled in the art without departing from the true spirit and scope of the disclosure. The scope of the present invention is defined by the appended claims and equivalents thereof.

What is claimed is:

1. An electronic cigarette, defining a gas passage for smoking, the electronic cigarette is provided with a gas valve for switching the gas passage.

2. The electronic cigarette according to claim 1, wherein the gas valve is set in the suction nozzle cover for switching on or off the suction nozzle cover.

3. The electronic cigarette according to claim 2, wherein the gas valve comprises a bottom seat and columns disposed at a first side of the bottom seat, the columns are spaced therefrom to form a ventilation groove for aerosol flowing, a bottom of the ventilation groove is formed by a part area of the first side; there are two columns, and the cross-section of the columns is arcuate, and the two columns are provided with two planar surfaces opposite to one another and symmetrical disposed.

4. The electronic cigarette according to claim 2, wherein the gas valve comprises a bottom seat and a column disposed at a first side of the bottom seat, the column axially defines a cavity therein, a distal end of the column radially defines an air vent therein; the air vent communicates with the aerosol passage in the suction stem and the cavity, the first side of the bottom seat defines a groove therein, the groove is formed by the cavity extending from the first side toward a second side of the bottom seat, and the groove communicates the cavity with outside.

5. The electronic cigarette according to claim 4, wherein a wall of the suction hole of the suction nozzle cover extends inward to form a sidewall, the sidewall of the suction hole blocks the air vent when pulling out the gas valve, or exposes the air vent when pressing the gas valve.

6. The electronic cigarette according to claim 3 or claim 4, wherein a distal end of the column extends outward to form a stopping part capable of preventing the gas valve escaping from the through-hole of the suction nozzle cover.

7. The electronic cigarette according to claim 3 or claim 4, wherein the bottom seat is truncated cone-shaped, and a diameter of the first side opposite to the suction nozzle cover is smaller than a diameter of the second side.

8. The electronic cigarette according to claim 1, wherein the suction stem further comprises a first connector disposed at the other end of a suction cylinder of the suction stem and connected with the power supply rod.

9. The electronic cigarette according to claim 8, wherein the power supply rod comprises a battery tube and a battery disposed in the battery tube; one end of the battery tube disposes a second connector coupled to the first connector, the other end of the battery tube is provided with a switch module and a light cap assembly; both the first connector and the second connector comprises an outer electrode ring, an insulation ring and an inner electrode in turn nested.

10. The electronic cigarette according to claim 9, wherein the suction stem comprising an atomizer disposed in the suction cylinder operable to produce aerosol; the atomizer comprises an atomization chamber formed in a liquid-storage piece sleeved on a catheter, and two ends are sealed, and a heater disposed in the atomization chamber; two ends of the atomization chamber are sealed by a liquid-blocking seat and the outer electrode ring respectively.

11. The electronic cigarette according to claim 10, wherein the heater comprises a liquid-guiding piece of which two ends extend out of an outer sidewall of the catheter and mutually abuts with the liquid-storage piece, and a heating wire winding on an outer surface of the liquid-storage piece; two ends of the heating wire are electrically connected to the inner electrode and the outer electrode ring respectively.

12. The electronic cigarette according to claim 2, wherein the gas valve is rotatably fitted to the suction nozzle cover, the suction nozzle cover comprises a bottom wall and an annular side wall longitudinally extending from a periphery of the bottom wall, the bottom wall defines the suction hole; the gas valve comprises a bottom cover and an annular side wall longitudinally extending from a periphery of the bottom cover, and the bottom cover defines a via hole selectably connected with the suction hole.

13. The electronic cigarette according to claim 12, wherein the bottom wall of the suction nozzle cover racially extends outwards to form an annular mounting flange; the gas valve defines an annular groove in its side wall inner; and the annular mounting flange is fitted in the annular groove.

14. The electronic cigarette according to claim 13, wherein the side wall of the suction nozzle cover forms a mounting step; and a distal end of the side wall of the gas valve rests on the mounting step.

15. The electronic cigarette according to claim 2, the gas valve comprises a sealing stopper inserted in the suction nozzle cover and a valve cover flexibly connected with the sealing stopper; the sealing stopper defines a smoke outlet communicated with an inner of the suction nozzle cover; and the valve cover comprises a flexible connection flexibly engaged with the sealing stopper, a lip connected with the flexible connection, and a sealing column formed on the lip for tightly inserted in the smoke outlet.

16. The electronic cigarette according to claim 1, wherein the power supply rod comprises a first power cylinder with the battery therein and a second power cylinder slidably sleeved with the first power cylinder, and the gas valve is set between the two power cylinders.

17. The electronic cigarette according to claim 16, wherein the gas valve comprises a valve plug disposed in an inner wall of the first power cylinder and a sealing sheath disposed in an inner wall of the second power cylinder.

18. The electronic cigarette according to claim 17, wherein the valve plug comprises an inserting portion fixed in the inner wall of the first power cylinder and a sliding column extending from one end of the inserting portion and axially towards the second power cylinder; the sliding column therein defines a cavity communicated with an inner of the inserting portion; and a side wall of the sliding column defines a vent hole communicated with the cavity.

19. The electronic cigarette according to claim 18, wherein the sealing sheath is sleeved on the sliding column; when the second power cylinder is departed from the first power cylinder, the sealing sheath completely seals off the vent hole in the sliding column.

20. The electronic cigarette according to claim 19, wherein an end of the sliding column is sleeved with a stopping ring to prevent the sealing sheath sliding off the sliding column.
